(19) United States
(12) Patent Application Publication
(10) Pub. No.: US 2022/0027963 A1
(43) Pub. Date: Jan. 27, 2022

(54) Vehicle Valuation Engine to Determine Valuation Based on Usage and Fault History

(71) Applicant: Allstate Insurance Company, Northbrook, IL (US)

(72) Inventor: Emad Isaac, Downers Grove, IL (US)

(21) Appl. No.: 16/936,633

(22) Filed: Jul. 23, 2020

(51) Int. Cl. G06Q 30/02; G01D 21/02; G06Q 10/00; G07C 5/08

(52) U.S. Cl. CPC G06Q 30/0278; G07C 5/0808; G06Q 10/20; G01D 21/02

(57) ABSTRACT

Methods, computer-readable media, software, and apparatuses may assist in determining the value of a vehicle, based on vehicle usage information, sensor data, and/or fault codes generated by the vehicle. The sensor data and/or the fault codes may be compared to a pre-determined grouping, and the vehicle value may be based in part on a cost of a repair associated with the pre-determined grouping.

### FIELD OF ART

Aspects of the disclosure generally relate to methods and computer systems, including one or more computers particularly configured and/or executing computer software. More specifically, aspects of this disclosure relate to methods and systems for determining the value of a vehicle based on vehicle usage information and a fault history of the vehicle.

### BACKGROUND

It is common for insurance providers to offer automobile insurance to consumers who want to protect against a financial loss that may be associated with damage or loss of a vehicle. An insurance provider may offer a policy to cover the replacement value of a vehicle. If a loss of the vehicle should occur, the insurance provider must determine the value of the vehicle, in order to determine the amount of payment to the consumer. The value of the vehicle typically may be found by referring to published guides which list wholesale and retail values for similar vehicles.

In addition to insurance providers, consumers may wish to determine a value of a vehicle when they are planning to purchase a vehicle, or sell a currently owned vehicle. Used car dealers may wish to determine a value of a vehicle that they are considering for purchase or sale, so that it may be priced appropriately. Lenders may also wish to determine a value of a vehicle in order to offer a loan to a consumer who wishes to purchase the vehicle.

The published guides may provide an average value of a vehicle, based on sales of similar models, but these guides do not account for particular usage or fault history of the vehicles. Accordingly, insurance providers, consumers, used car dealers, and lenders may benefit from a more accurate valuation of a particular vehicle.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable storage media, software, systems, and apparatuses for determining the value of a vehicle based on vehicle usage information and a fault history of the vehicle.

In some aspects, fault codes may be received from a vehicle and compared to pre-determined groupings of fault codes, in order to determine whether the fault codes match the pre-determined grouping. A cost of a repair associated with the pre-determined grouping may be determined and used in determining the value of the vehicle. In addition to the fault codes matching a pre-determined grouping, vehicle usage information may be captured and the value of the vehicle may be determined further based on the usage information.

In an embodiment, sensor data may be received from the vehicle and considered with the usage information and the fault codes in the determination of the value of the vehicle. In some embodiments, sensor data may be received from the vehicle and compared to pre-determined groupings of sensor data, in order to determine whether the sensor data matches a pre-determined grouping. A cost of a repair associated with the pre-determined grouping may be determined and used in determining the value of the vehicle. In addition to the sensor data matching a pre-determined grouping, vehicle usage information may be determined and the value of the vehicle may be determined, based on the usage information.

Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The present invention is illustrated by way of example and is not limited by the accompanying figures in which like reference numerals indicate similar elements and in which:

FIG. 1 illustrates an example computing device as may be used in accordance with one or more aspects described herein.

FIG. 2 depicts an example network environment in which various aspects of the present disclosure may be implemented in accordance with one or more exemplary embodiments.

FIG. 3 illustrates an exemplary method in accordance with one or more aspects described herein.

FIG. 4 illustrates an exemplary method in accordance with one or more aspects described herein.

FIG. 5 illustrates another exemplary method in accordance with one or more aspects described herein.

### DETAILED DESCRIPTION

In accordance with various aspects of the disclosure, methods, computer-readable media, software, and apparatuses are disclosed for determining the value of a vehicle based on vehicle usage information and a fault history of the vehicle.

When a problem occurs in a vehicle system, a fault code may be set by a computer in the vehicle, or a sensor may sense an abnormal condition and cause an indication to the driver. These fault codes and sensor data are typically discrete indicators, and, when considered alone, may not clearly indicate the problem with the vehicle. For example, a “headlight out” indicator, by itself, may cause a user to believe that a bulb has failed, while there may be other component failures which could also cause the “headlight out” indicator.

An algorithm can be trained to recognize that the presence of particular sensor data and/or one or more fault codes comprising a particular grouping is an indication of a particular component failure. For example, a machine learning algorithm may be trained on historical repair data to recognize that the presence of particular sensor data and/or one or more fault codes comprising a particular grouping is an indication of a particular component failure. Other algorithms may also be used. Continuing the example above, if an onboard computer had output a fault code associated with a headlight circuit in a central electronic module, then the algorithm may recognize that the central electronic module (CEM) may be faulty, rather than the bulb.

In accordance with various aspects of the disclosure, by comparing groups of fault codes and sensor data to pre-determined groupings, the vehicle valuation system may determine a failure that has occurred. In addition, by referencing cost data associated with repairs of various failures, a cost can be determined for a corresponding repair, and this cost may be subtracted from the vehicle value. For example, if the vehicle had been determined to be valued at $5000, and sensor data and fault code grouping indicates that the CEM needs to be replaced, which may cost $1700 for parts and labor, then the vehicle valuation system may subtract $1700 from the vehicle value, thereby valuing the vehicle at $3300.

In accordance with various aspects of the disclosure, vehicle usage data may further be considered when determining the value of the vehicle. For example, the vehicle odometer reading may be an indicator which, when considered with the sensor data and fault codes, may further provide an indication of a likely failure in a vehicle system. For example, given a particular sensor and/or fault, a likely cause may be different when generated in a high mileage vehicle versus being generated by a low mileage vehicle. For example, a high mileage vehicle may be more likely to have a worn-out component, in comparison to a low mileage vehicle. In some examples, machine learning may be used to evaluate data and generate a likelihood of failure.

In the following description of the various embodiments of the disclosure, reference is made to the accompanying drawings, which form a part hereof, and in which are shown by way of illustration, various embodiments in which the disclosure may be practiced. It is to be understood that other embodiments may be utilized and structural and functional modifications may be made.

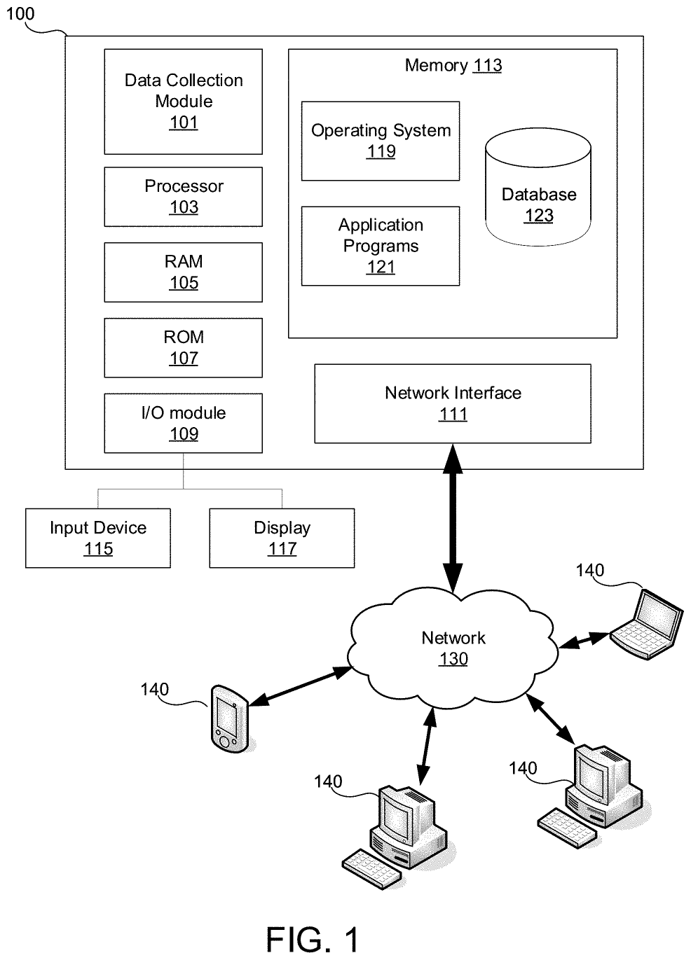

In one or more arrangements, aspects of the present disclosure may be implemented using a computing device. FIG. 1 illustrates a block diagram of an example vehicle valuation system 100 that may be used in accordance with aspects described herein. The vehicle valuation system 100 may be a computing device, such as a personal computer (e.g., a desktop computer), server, laptop computer, notebook, tablet, smartphone, etc. The vehicle valuation system 100 may be implemented with one or more processors 103 and one or more storage units (e.g., databases 123, RAM 105, ROM 107, and other computer-readable media), one or more application specific integrated circuits (ASICs), and/or other hardware components (e.g., resistors, capacitors, power sources, switches, multiplexers, transistors, inverters, etc.). Throughout this disclosure, the vehicle valuation system 100 may refer to the software and/or hardware used to implement the vehicle valuation system 100. In cases where the vehicle valuation system 100 includes one or more processors, such processors may be specially configured to perform the processes disclosed herein. Additionally, or alternatively, the vehicle valuation system 100 may include one or more processors configured to execute computer-executable instructions, which may be stored on a storage medium, to perform the processes disclosed herein. The processor(s) 103 may be capable of controlling operations of the vehicle valuation system 100 and its associated components, including RAM 105, ROM 107, an input/output (I/O) module 109, a network interface 111, and memory 113. For example, processor(s) 103 may each be configured to read/write computer-executable instructions and other values from/to the RAM 105, ROM 107, and memory 113. The vehicle valuation system 100 may have a data collection module 101 for retrieving and/or analyzing data as described herein.

The I/O module 109 may be configured to be connected to an input device 115, such as a microphone, keypad, keyboard, touchscreen, and/or stylus through which a user of the vehicle valuation system 100 may provide input data. The I/O module 109 may also be configured to be connected to a display device 117, such as a monitor, television, touchscreen, etc., and may include a graphics card. The display device 117 and input device 115 are shown as separate elements from the vehicle valuation system 100; however, they may be within the same structure. On some vehicle valuation systems 100, the input device 115 may be operated by users to interact with the vehicle valuation system 100, for example, to input vehicle information, as described in further detail below. System administrators may use the input device 115 to make updates to the vehicle valuation system 100, such as software updates. Meanwhile, the display device 117 may assist the system administrators and users to confirm/appreciate their inputs.

The memory 113 may be any computer-readable medium for storing computer-executable instructions (e.g., software). The instructions stored within memory 113 may enable the vehicle valuation system 100 to perform various functions. For example, memory 113 may store software used by the vehicle valuation system 100, such as an operating system 119 and application programs 121, and may include an associated database 123. In some embodiments, the application programs 121 may include one or more algorithms, as discussed below.

The network interface 111 may allow the vehicle valuation system 100 to connect to and communicate with a network 130. The network 130 may be any type of network, including a local area network (LAN) and/or a wide area network (WAN), such as the Internet, a cellular network, or a satellite network. Through the network 130, the vehicle valuation system 100 may communicate with one or more other computing devices 140, such as laptops, notebooks, smartphones, tablets, personal computers, servers, vehicles, repair shops, etc. The computing devices 140 may also be configured in a similar manner as vehicle valuation system 100. In some embodiments, the vehicle valuation system 100 may be connected to the computing devices 140 to form a “cloud” computing environment.

The network interface 111 may connect to the network 130 via communication lines, such as coaxial cable, fiber optic cable, etc., or wirelessly using a cellular backhaul or a wireless standard, such as IEEE 802.11, IEEE 802.15, IEEE 802.16, etc. In some embodiments, the network interface may include a modem. Further, the network interface 111 may use various protocols, including TCP/IP, Ethernet, File Transfer Protocol (FTP), Hypertext Transfer Protocol (HTTP), etc., to communicate with other computing devices 140.

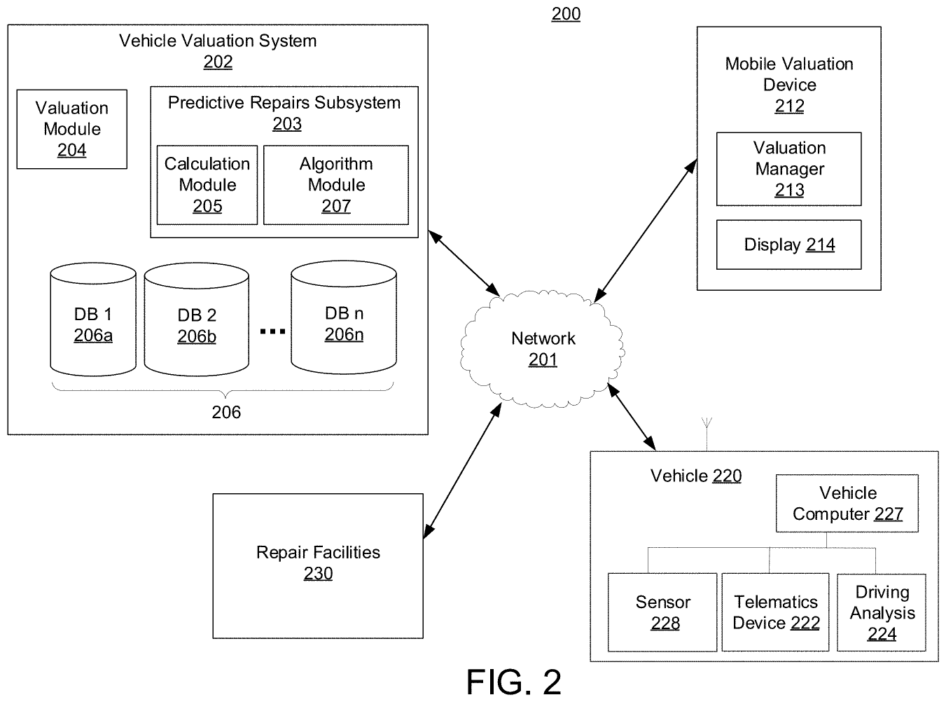

The computerized methods for determining the value of a vehicle based on vehicle usage information and a fault history of the vehicle, as disclosed herein, may be implemented on one or more vehicle valuation systems 100 used in various network environments. FIG. 2 illustrates an example network environment for implementing methods in accordance with aspects of the present disclosure.

As shown in FIG. 2, the network environment 200 may include a network 201 configured to connect a vehicle valuation system 202, mobile valuation device 212, vehicle 220, and computing devices associated with repair facilities 230. The vehicle valuation system 202 may be the same as or at least similar to the vehicle valuation system 100 described above with reference to FIG. 1. Similarly, the mobile valuation device 212 may also be the same as or at least similar to the vehicle valuation system 100 described above with reference to FIG. 1. In various embodiments, the mobile valuation device 212 may perform similar functions as the vehicle valuation system 202, or may be used as a remote interface to the vehicle valuation system 202. It is understood that there may be any number of components 212, 220, and 230 in the network environment 200. In at least some arrangements, the system may be expandable such that additional computing devices associated with other types of entities may be connected, as desired.

The network 201 may be any type of network, like the network 130 described above, and may use one or more communication protocols (e.g., protocols for the Internet (IP), Bluetooth, cellular communications, satellite communications, and the like) to connect computing devices and servers within the network environment 200 so they may send and receive communications between each other. In particular, the network 201 may include a cellular network and its components, such as cell towers.

Accordingly, for example, the mobile valuation device 212 (e.g., a smartphone, laptop, tablet, and the like) may communicate, via a cellular backhaul of the network 201, with vehicle valuation system 202 to transmit information regarding fault codes, sensor data, and/or usage information associated with a vehicle 220, and/or to receive information regarding the value of the vehicle 220. In some embodiments, the mobile valuation device 212 may geotag data transmitted to the vehicle valuation system 202 with location data. For example, the mobile valuation device 212 may transmit the geotag data regarding the location of the vehicle 220 to the vehicle valuation system 202 so that the vehicle valuation system 202 may determine a local repair cost of the vehicle 220, or a local value of the vehicle 220, based on the geotagged location data. The geotag data may capture location information from, for example, a GPS receiver in the mobile valuation device 212. A consumer, a bank loan officer, a used car salesman, or an insurance agent may use the mobile valuation device 212 to interact with the vehicle valuation system in determining vehicle value. In another embodiment, the mobile valuation device 212 may communicate back and forth with the vehicle valuation system 202 over the Internet, such as through a web portal. In some embodiments, the mobile valuation device 212 may communicate with repair facilities 230 to obtain a repair history and/or a fault history of the vehicle 220. Repair facilities 230 may include an automotive repair shop, a manufacturer of the vehicle, or a roadside assistance service, among others. The mobile valuation device 212 may communicate with the vehicle 220 in order to receive fault codes, sensor data, usage information, among others. In some embodiments, the mobile valuation device 212 may provide a wired interface which is configured to communicate directly with various on-board vehicle computers.

In some embodiments, the vehicle valuation system 202 may communicate with repair facilities 230 to obtain the maintenance/repair history and/or the fault history of the vehicle 220. The vehicle valuation system 202 may communicate with the vehicle 220, for example, via the network 201, in order to receive fault codes, sensor data, and usage information, among others. The vehicle valuation system 202 may record the maintenance/repair history and/or the fault history of the vehicle 220 in a blockchain.

Although FIG. 2 illustrates only one vehicle 220, the vehicle valuation system 202 may be configured to communicate with a plurality of vehicles 220 simultaneously (e.g., at or around the same time), and the plurality of vehicles 220 may be associated with multiple individuals. The vehicle valuation system 202 may receive fault codes, sensor data, and/or usage information for multiple vehicles simultaneously and/or in real-time, analyze the fault codes, sensor data, and/or usage information to assess vehicle values for multiple vehicles simultaneously and/or in real-time. The multiple vehicles 220 may be any type of vehicle, including a car, truck, motorcycle, airplane, drone (or other automated device), bus, boat, or helicopter, and the like, wherein the multiple vehicles 220 may be the same or may vary.

As illustrated in FIG. 2, vehicle 220 may include one or more sensors 228 capable of detecting and recording various conditions at the vehicle and/or operational parameters of the vehicle. For example, sensor 228 may detect and store and/or provide data corresponding to the status of various vehicle systems or components, the vehicle's location (e.g., GPS coordinates), time, travel time, speed and direction, rates of acceleration or braking, gas mileage, and specific instances of sudden acceleration, braking, swerving, other vehicle dynamics (vibration detected, sound detected etc.), and distance traveled. Sensor 228 also may detect and store data received from the vehicle's 220 internal systems, such as impact to the body of the vehicle, air bag deployment, headlights status, and brake light status.

Additional sensors 228 may detect and store data relating to the maintenance or status of the vehicle 220 or of systems/components therein, such as the engine status, oil level, oil condition, engine coolant temperature, coolant level, odometer reading, fuel level, engine revolutions per minute (RPMs), O₂ exhaust readings, exhaust backpressure, fuel efficiency, bulb status, and/or tire pressure, among others.

Certain sensors 228 also may collect information regarding routes taken by the vehicle and pattern of driving (e.g., continuous driving, parking, stop-and-go traffic, etc.). A Global Positioning System (GPS), locational sensors positioned inside the vehicle 220, and/or locational sensors or devices external to the vehicle 220 may be used to determine the route, speed, and other vehicle position/location data.

The data collected by sensor 228 may be stored and/or analyzed within the vehicle 220, such as for example by a vehicle computer 227 integrated into the vehicle, and/or may be transmitted to one or more external devices. For example, as shown in FIG. 2, sensor data may be transmitted via a telematics device 222 to one or more remote computing devices, such as mobile valuation device 212, repair facilities 230, vehicle valuation system 202, and/or other remote devices.

The telematics device 222 may receive fault codes from vehicle computer 227 and sensor data from sensor 228, and may transmit the fault codes and sensor data to one or more external computer systems (e.g., vehicle valuation system 202, mobile valuation device 212, or other entity) over a wireless transmission network. Telematics device 222 also may be configured to detect or determine additional types of data relating to a condition of the vehicle 220. The telematics device 220 also may store the type of vehicle 220, for example, the make, model, trim (or sub-model), year, and/or engine specifications, as well as other information, such as vehicle owner or driver information, and odometer reading for the vehicle 220.

In some cases, the telematics device 222 may be configured to be plugged into the vehicle's 220 on-board diagnostic system (OBD) (e.g., plugged in through an OBD II connector), or otherwise installed in the vehicle 220, in order to collect data. The telematics device 222 may also collect GPS coordinates, such as through its own GPS receiver. In the example shown in FIG. 2, the telematics device 222 may receive sensor data from sensor 228, and may transmit the data to a vehicle valuation system 202. In some embodiments, sensor 228 may capture data related to driving patterns, the driving patterns may include data indicative of one or more vehicle metrics or vehicle telematics data, such as based on a speed driven, acceleration, braking events, steering actions, turn signaling, and the like. In other examples, one or more of the sensors 228 or systems may be configured to receive and transmit data directly from or to the vehicle valuation system 202, without using a telematics device 222. For instance, telematics device 222 may be configured to receive and transmit data from certain sensors 228 or systems, while other sensors or systems may be configured to directly receive and/or transmit data to a vehicle valuation system 202, without using the telematics device 222. Thus, telematics device 222 may be optional in certain embodiments.

Vehicle 220 may have one or more vehicle computers 227 which may monitor and/or test various vehicle systems and/or components to verify proper operation or to detect faults. Upon detecting a fault or abnormal condition, the vehicle computer 227 may store various fault codes, such as one or more OBD codes, and may provide an indicator to the driver that a vault has been detected. The one or more OBD codes may be read using an OBD code reader or other device that is capable to interface with an OBD port on the vehicle 220. For example, in some embodiments, mobile valuation device 212 may read the OBD codes via a connection to the OBD port, or may receive the OBD codes wirelessly, when transmitted by telematics device 222. In some examples, a vehicle 220 may display the OBD codes on an in-vehicle display.

A driver of the vehicle 220, or other individual, may interact with and operate a mobile valuation device 212 to capture fault codes and/or sensor data and to interface with the vehicle valuation system 202. In some embodiments, the mobile valuation device 212 may be a specialized mobile device (e.g., smartphone), a tablet, laptop, personal computer, and the like configured to perform or carry out aspects associated with the services described herein. Although only one mobile valuation device 212 is illustrated in FIG. 2, there may be any number of mobile valuation devices 212.

The mobile valuation device 212 may further comprise a valuation manager 213 and a display 214. The mobile valuation device 212 may be configured to execute the valuation manager 213 to present a user interface (e.g., a graphical user interface for a website, application, software program, and the like) on the display 214. The display 214 may comprise a monitor, television, touchscreen, and the like. The user interface of the valuation manager 213 may allow users to send and/or receive fault codes, sensor data, and vehicle valuation information, among others. The user interface may also allow individuals to update account information or preferences for services provided by the vehicle valuation system 202.

The valuation manager 213 may be a self-sufficient program or may be a module of another program, such as a program used to collect information utilized by the vehicle valuation system 202. The valuation manager 213 may be configured in a similar manner as the data collection module 101 or configured to perform similar functions as those performed by the data collection module 101.

In some embodiments, the valuation manager 213 may be downloaded or otherwise installed onto the mobile valuation device 212 using known methods. Different mobile valuation devices 212 may install different versions of the valuation manager 213, depending on their platform. For example, a mobile valuation device 212 (e.g., a smartphone) running a first operating system may download a different version of the valuation manager 213 than a mobile valuation device 212 running a second operating system, different from the first operating system.

An individual or user may launch the valuation manager 213 by, for example, operating buttons or a touchscreen on the mobile valuation device 212. Additionally, or alternatively, the mobile valuation device 212 may be configured to execute a web browser (e.g., an application for accessing and navigating the Internet) to access a web page providing an interface for the vehicle valuation system 202. In some embodiments, the mobile valuation device 212 may also be configured to collect information. For example, the valuation manager 213 or another program installed on the mobile valuation device 212 may instruct the mobile valuation device 212 to collect data. For example, the valuation manager 213 may collect one or more fault codes, sensor data, and/or usage data from vehicle 220. Once the data has been collected, the valuation manager 213 may be configured to send the collected data to the vehicle valuation system 202 instantaneously, automatically, or at a later time.

FIG. 2 also illustrates repair facilities 230, which may represent one or more computing devices that are operated by employees at the repair facilities 230. The repair facilities 230 may be connected to the vehicle valuation system 202 through one or more servers or systems that are communicatively coupled through the network 201. In some embodiments, the vehicle valuation system 202 may query the repair facilities 230 in order to receive a repair history of the vehicle 220. In some embodiments, the vehicle valuation system 202 may query the repair facilities 230 in order to determine a cost estimate for repairing the vehicle 220, to correct for a problem indicated by the fault codes and or sensor data received from the vehicle 220.

FIG. 2 further illustrates example subsystems within the network environment 200. That is, the vehicle valuation system 202 may comprise a valuation module 204, a predictive repairs subsystem 203, and a plurality of databases 206. The valuation module may be configured to determine a value for a particular vehicle 220, based on available valuation data for similar model vehicles, and based on usage data, fault codes, and/or a cost to repair the vehicle 220. In some embodiments, the vehicle valuation module may retrieve from a database an average value of a vehicle and may deduct an expected cost of repairing the vehicle to arrive at a vehicle valuation. The expected cost of repairing the vehicle may be determined by the predictive repairs subsystem 203.

The predictive repairs subsystem 203 may include one or more application servers, computing devices, and other equipment used to implement and provide the services described herein. For example, the predictive repairs subsystem 203 may include a calculation module 205 that may be configured with programmed instructions to determine and/or assign a predetermined cost for repairing the vehicle 220.

The predictive repairs subsystem 203 may also include an algorithm module 207 which may be configured with one or more rules and logic for determining a repair for correcting a problem as indicated by one or more fault codes and sensor data. In some embodiments, the algorithm module 207 may be trained on a historical database of repair actions, fault codes, and sensor data. Thereby, the algorithm module 207 may be able to determine a likely repair needed, based on various fault codes and sensor data. In some embodiments, the algorithm module 207 may predict that vehicle 220 may require a particular repair, based on a history of similar vehicles needing the particular repair, or of similar vehicles presenting with a similar set of fault codes and/or sensor data. In additional embodiments, the algorithm module 207 may identify faulty vehicle components, based on fault codes, sensor data, and/or the repair history of similar vehicles. In some embodiments, the algorithm module 207 may be trained on a historical database of insurance claims related to vehicle accidents wherein a vehicle component failure caused the accident. In some embodiments, the algorithm module 207 may include a machine learning engine which may use supervised learning and employ supervised algorithms, such as linear regression, random forest, nearest neighbor, decision trees, Support Vector Machines (SVM), and/or logistical regression, among others. In some other embodiments, the machine learning engine may use unsupervised learning and employ unsupervised algorithms, such as k-means clustering and/or association rules, among others. In still other embodiments, the machine learning engine may use semi-supervised learning and/or reinforcement learning. While described in the context of machine learning algorithms, it should be understood that the algorithm module 207 may include a number of algorithms, some of which may not be machine learning algorithms.

The predictive repairs subsystem 203 may include functionality that may be distributed among a plurality of computing devices. For example, the predictive repairs subsystem 203 may comprise further subsystems, including client-side subsystems and server-side subsystems. The client-side subsystem may interface with the mobile valuation device 212, the plurality of vehicles 220, and/or the repair facilities 230, whereas the server-side subsystem may interface with application servers and computing devices which handle a variety of tasks related to for determining standard amounts for repairing vehicles and determining vehicle valuations.

The subsystems, application servers, and computing devices of the predictive repairs subsystem 203 may also have access to the plurality of databases 206. In some embodiments, the plurality of databases 206 may be incorporated into the predictive repairs subsystem 203 or may be separate components from the predictive repairs subsystem 203.

As an example, the plurality of databases 206 (e.g., databases 206a-206n) may comprise a database of average retail values and/or wholesale values for various year models of vehicles. The databases 206 may comprise a database mapping fault codes and/or sensor data and groupings to corresponding repairs. For example, the database 206 may include a mapping that lists the grouping of OBD code CEM-8A20 and a left low beam headlight bulb out sensor as mapping to a failed ECM. In some embodiments, any grouping of fault codes and/or sensor data may be mapped to multiple potential failed components, each with a probability to indicate the likelihood of being the correct failure.

In some embodiments, the vehicle valuation system 202 may determine a failed component based on sensor data, without any fault codes. Some vehicle components may not be electrically connected, but the vehicle valuation system 202 may determine that such a component has failed by monitoring dynamic sensors, which may detect an abnormal vibration. For example, a particular vibration of a brake disc may indicate that the brake pads have worn out.

The databases 206 may comprise a database storing labor requirements, such as time required for each repair, and costs for parts associated with various repairs. In some embodiments, the databases 206 may include adjustment factors to adjust parts and or labor to various locations, for example, so that a lower labor rate can be used in calculating repair costs in lower cost locations.

The data stored in the plurality of databases 206 may be collected and compiled by the mobile valuation device 212, the vehicle valuation system 202, the predictive repairs subsystem 203, by servers and subsystems within the predictive repairs subsystem 203, or by the valuation module 204. In another example, one or more databases 206 may also include predefined rules and other information to enable the methods disclosed herein. For example, one or more databases 206 may contain historical repair data, or other applicable data for use in training the algorithm module 207.

In some embodiments, the calculation module 205 may determine that the replacement of certain vehicle components (e.g., head gasket) may involve higher labor fees than the fees for replacing other components (e.g., central electronic module) and thereby use the higher labor fees in calculating the cost of repair. In some aspects, the calculation module 205 may determine labor costs for various locations and use the local labor costs in determining the cost of making a repair. For example, the vehicle valuation system 202 may determine a standard amount for a repair based on the location of the repair facility 230, such that a first repair facility 230 in a first location (e.g., state of California) may be assigned a higher standard amount for the repair than a second repair facility 230 in a second location (e.g., state of Georgia).

Additionally, the vehicle valuation system 202 may determine which specific auto parts are faulty in a vehicle 220 based on analyzing information received from the telematics device 222 in the vehicle 220. The vehicle valuation system 202 may provide this information to repair facilities 230.

Based on previous data on how long certain repairs take for various vehicle components (as determined from, for example, historical repair data), the vehicle valuation system 202 may determine a length of time for which an individual may need a rental car while the vehicle 202 is being repaired. The vehicle valuation system 202 may interface with rental car agencies in order to determine a cost for a rental vehicle for the length of time.

In additional embodiments, the vehicle valuation system 202 may modify standard amounts for repairs, based on data regarding actual costs of repairs received from the repair facilities 230. That is, the vehicle valuation system 202 may continuously update predetermined repair costs provided for different types of repair.

In some embodiments, the vehicle valuation system 202 may determine what vehicle component or system has failed and/or what repair is needed, as a service to a user who wants to troubleshoot problems with their vehicle, based on fault codes and/or sensor data. As discussed above, the user may interact with the vehicle valuation system 202 via use of the mobile valuation device 212, and may provide fault codes, sensor data, and other vehicle information to the vehicle valuation system 202. The vehicle valuation system 202 may, based on these inputs, refer to one or more of the databases 206 and/or use the predictive repairs subsystem 203 to determine what caused the vehicle 220 to generate the fault codes and sensor data. In some embodiments, after receiving the fault codes and/or sensor data and determining that the fault codes and/or sensor data include a pre-determined grouping, the vehicle valuation system 202 may determine what repair would be needed to fix the problem causing the pre-determined grouping and may output an indication of this repair, including an estimated cost of the repair. For example, in this manner, the vehicle valuation system 202 may be used by individuals to help them understand what is wrong with their vehicle and to understand the expected cost of making the repair.

In some embodiments, the vehicle valuation system 202 may provide a service to a user to help the user find a repair facility 230 to perform a repair at a low price. In these embodiments, the vehicle valuation system 202 may identify repair facilities 230 nearby the user and send an identified repair to the identified repair facilities, who may then submit quotes to perform the service. The quotes may be provided to the user, for example, via the mobile valuation device 212 or via a form of communication such as email, thereby enabling the user to choose a repair facility 230 offering an agreeable price for the repair.

In additional embodiments, the vehicle valuation system 202 may conduct quality checks to evaluate the quality of repairs performed by the repair facilities 230. For example, the vehicle valuation system 202 may transmit a request for performing a quality review to one or more repair facilities 230, and the vehicle valuation system 202 may further receive a confirmation from the one or more repair facilities 230 for performing the quality review. The vehicle valuation system 202 may be configured to determine whether a plurality of vehicles 220 that have been repaired by the one or more repair facilities 230 pass inspection standards. For example, the inspection standards may comprise industry standards, original equipment (OE) standards, safety regulations, and/or standards set by different manufacturers. Different manufacturers may have different standards such as for repairing certain vehicle parts while replacing other vehicle parts. In some cases, the vehicle valuation system 202 may utilize an algorithm to determine/check whether standards have been met, such as by checking headlights on a vehicle, checking wipers on the vehicle, determining whether all fault codes have been cleared, and the like. The vehicle valuation system 202 may also capture and/or utilize one or more photos of the vehicle being repaired to document the repair procedure (which may be useful for quality checks).

Thus, the vehicle valuation system 202 may determine whether the various standards have been met in vehicle repairs by the one or more repair facilities 230, and the vehicle valuation system 202 may also identify customer satisfaction of quality of repairs performed by one or more repair facilities 230 based on one or more surveys, and number of returns to the one or more repair facilities 230 for additional repairs. For example, the vehicle valuation system 202 may determine customer satisfaction based on how often customers returned to a repair facility 230 for vehicles that were not repaired according to the customer's satisfaction. The repair facilities 230 may be responsible for repairing vehicles according to the industry standards and to the customer's satisfaction, such that a predetermined level for quality of repairs is met.

If the vehicle valuation system 202 determines that one or more standards have not been met by a particular repair facility 230 and/or that the repair facility 230 does not achieve the predetermined level of quality for repairs, then the vehicle valuation system 202 may determine that a past repair may have been poorly done and this may cause a reduction in vehicle valuation. In other embodiments, the vehicle valuation system 202 may review a predetermined subset (e.g., a predetermined percentage) of the vehicles 220 that are repaired by the repair facility 230 to assess quality of repairs conducted by the repair facility 230.

In some embodiments, based on algorithms discussed above, the vehicle valuation system 202 may determine that a vehicle 220 may expect to, at some point in the future (e.g. a future data or at a future mileage), experience certain failed components, based on the repair history or fault history of similar vehicles, and may adjust a vehicle valuation accordingly. The vehicle valuation system 202 may provide a vehicle owner with an indication of components that may be expected to fail, thereby enabling the vehicle owner to perform preventative maintenance or have a mechanic check the components.

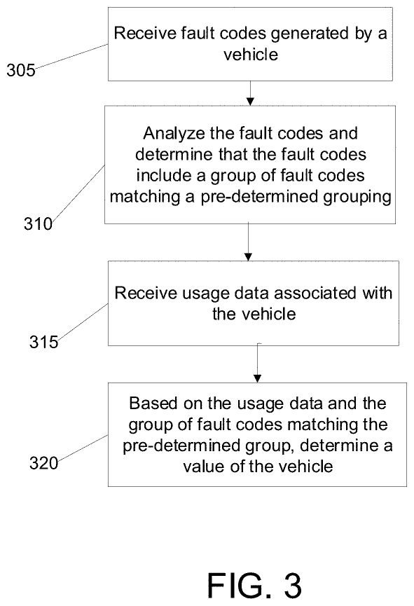

FIG. 3 illustrates an exemplary method in accordance with one or more aspects described herein. At step 305, fault codes generated by the vehicle 220 may be received. For example, the fault codes may be received from vehicle 220, repair facilities 230, and/or mobile valuation device 212. In various embodiments, the fault codes may include current fault codes and/or historical fault codes. In some embodiments, the fault codes may include fault codes that have been cleared on the vehicle 220. Cleared fault codes may, in some embodiments, be received from repair facilities 230, which may retain a repair history of the vehicle 220. In some embodiments, the fault codes may include OBD codes.

At step 310, the fault codes may be analyzed (e.g., using algorithms such as machine learning) and it may be determined that the fault codes include a group of fault codes that match a pre-determined grouping. For example, five fault codes may be received and it may be determined that three of the fault codes match a pre-determined grouping. A pre-determined grouping may include a group of fault codes that may occur due to a particular failure or abnormal condition in the vehicle 220. In some embodiments, the pre-determined groupings may be based on repair histories of a number of vehicles. In some other embodiments, the historical data associated with failures of vehicles similar to vehicle 220. The pre-determined groupings may be stored in one or more of databases 206a-206n. Accordingly, based on fault codes generated by the vehicle 220, the vehicle valuation system 202 may determine, or predict (e.g., based on algorithms such as machine learning), a vehicle repair that is needed, and may determine a cost of the needed repair, so that the cost may be considered when determining the value of the vehicle 200.

At step 315, usage data associated with the vehicle may be received. For example, the usage data may include a reading from the vehicle's odometer, an indication of miles driven since a prior service or repair, and/or time passed since a prior service or repair, among others. The usage data may be received from vehicle 220, the repair facilities 230, and/or mobile valuation device 212.

At step 320, a value of the vehicle may be determined, based on the usage data and the group of fault codes matching the pre-determined group. In some embodiments, the vehicle valuation system 202 may determine a cost associated with a repair corresponding to the pre-determined grouping. For example, the usage data and the pre-determined grouping of fault codes may indicate that an ignition coil associated with cylinder three has failed. Accordingly, the vehicle valuation system 202 may determine the cost of the ignition coil and the cost of the labor involved in replacing the ignition coil, and may reduce the value of the vehicle 220 by a similar amount.

In some embodiments, the usage data may indicate mileage added to vehicle 220 since the fault codes were generated. The vehicle valuation system 202 may further reduce the vehicle value if it is determined that the vehicle has continued in operation after the fault codes were generated. For example, this may be an indicator that more extensive damage may have occurred to the vehicle 220.

In some embodiments, the vehicle valuation system 202 may determine that a same grouping of fault codes had been previously generated by the vehicle 220. Such a determination may be an indication that the vehicle 220 had a chronic condition or that previous repairs had not lasted or been successful. Such a determination may alternatively indicate that the vehicle owner had cleared the codes and continued using the vehicle 220, without making repairs. The vehicle valuation system 202 may reduce the vehicle value based on these indications.

In some embodiments, the vehicle valuation system 202 may determine that a same grouping of fault codes had been previously generated by the vehicle 220 by communicating with repair facilities 230. For example, the repair facilities 230 may have a repair history of vehicle 220 and may provide the repair history to the vehicle valuation system 202. According to some aspects, the repair history may be stored by the vehicle valuation system 202, for example in one of the databases 206a-206n. In some embodiments, the vehicle valuation system 202 may receive an indication from the repair facilities 230 that the fault codes had been cleared without a repair being made.

According to some embodiments, the vehicle valuation system 202 may be in communication with an insurance provider's computing systems and may determine an insurance payment to be made for a loss of the vehicle 220, based on the vehicle value.

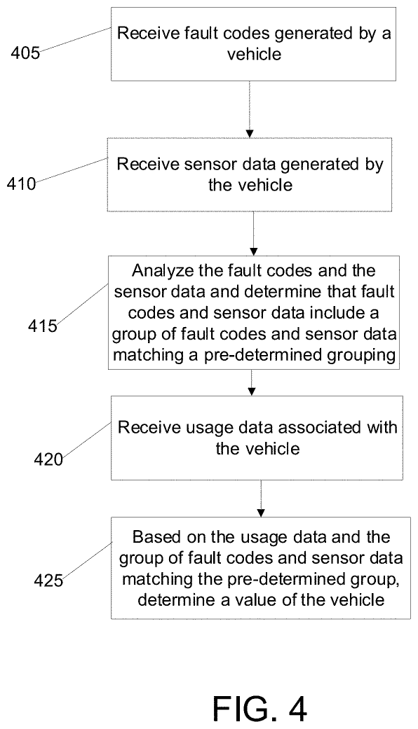

FIG. 4 illustrates an exemplary method in accordance with one or more aspects described herein. At step 405, fault codes generated by the vehicle may be received. For example, the fault codes may be received from vehicle 220, repair facilities 230, and/or mobile valuation device 212. In various embodiments, the fault codes and sensor data may include current values and/or historical values.

At step 410, sensor data generated by the vehicle may be received. For example, the sensor data may be received from vehicle 220, repair facilities 230, and/or mobile valuation device 212. In various embodiments, the sensor data may include current sensor data and/or historical sensor data. The sensor data may be indicative of an abnormal condition. In some embodiments, the sensor data may be indicative of a driving pattern or incident.

At step 415, the fault codes and sensor data may be analyzed (e.g., using algorithms such as machine learning) and it may be determined that the fault codes and sensor data include a group of fault codes and sensor data that matches a pre-determined grouping. For example, five fault codes and two sensor data may be received and it may be determined that three of the fault codes and one of the sensor data together match a pre-determined grouping.

At step 420, usage data associated with the vehicle may be received. As discussed above, usage data may include a reading from the vehicle's odometer, an indication of miles driven since a prior service or repair, and/or time passed since a prior service or repair, among others. The usage data may be received from vehicle 220, repair facilities 230, and/or mobile valuation device 212. In some embodiments, various vehicle sensors may provide information for determining the usage data. For example, sensors including an accelerometer, gyroscope, a microphone, a vibration detector, an odometer, the driving analysis system 224, or a navigation system may inform the usage data.

At step 425, a value of the vehicle may be determined, based on the usage data and the group of fault codes and sensor data matching the pre-determined group. For example, the usage data and the pre-determined grouping of fault codes and sensor data may indicate the head gasket in the vehicle 220 is leaking. This may be based the usage data indicating that the vehicle 220 is a high mileage vehicle, the sensor data may indicate that the coolant level is low, and the fault codes may indicate a misfire in cylinders one and two (e.g. P0301 for cylinder number 1, P0302 for cylinder number 2). For example, historical data may indicate that a leak in the head gasket may cause combustion gases to enter the coolant, thereby pressurizing the coolant tank and forcing the coolant level low, and at the same time, the leak in the head gasket may allow coolant to enter the combustion chambers, thereby causing misfires. Accordingly, the vehicle valuation system 202 may determine the cost of the head gasket and the cost of the labor involved in replacing the head gasket and may reduce the value of the vehicle 220 by a similar amount.

In some embodiments, the usage data may indicate mileage added to vehicle 220 since the fault codes and sensor data were generated. Similar to the above, the vehicle valuation system 202 may further reduce the vehicle value if it is determined that the vehicle has continued in operation after the fault codes were generated, as this may be an indicator that more extensive damage may have occurred to the vehicle 220.

In some embodiments, the vehicle valuation system 202 may determine that a same grouping of fault codes and sensor data had been previously generated by the vehicle 220. Such a determination may be an indication that the vehicle 220 had a chronic condition, or that previous repairs had not lasted or been successful, or that the vehicle owner had cleared the codes and continued using the vehicle 220, without making repairs. The vehicle valuation system 202 may reduce the vehicle value based on these indications.

In some embodiments, the vehicle valuation system 202 may determine that a same grouping of fault codes and sensor data had been previously generated by the vehicle 220 by communicating with repair facilities 230.

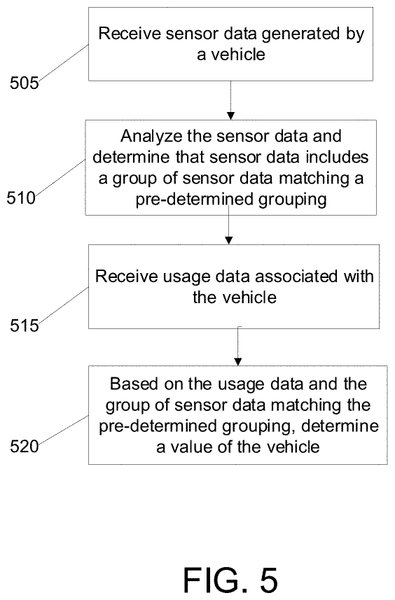

FIG. 5 illustrates an exemplary method in accordance with one or more aspects described herein. At step 505, sensor data generated by the vehicle may be received. For example, the sensor data may be received from vehicle 220, repair facilities 230, and/or mobile valuation device 212. In various embodiments, the sensor data may include current sensor data and/or historical sensor data.

At step 510, the sensor data may be analyzed (e.g., using algorithms such as machine learning) and it may be determined that the sensor data includes a group of sensor data that matches a pre-determined grouping. For example, five sensor data may be received and it may be determined that three of the sensor data match a pre-determined grouping.

At step 515, usage data associated with the vehicle may be received. As discussed above, usage data may include a reading from the vehicle's odometer, an indication of miles driven since a prior service or repair, and/or time passed since a prior service or repair, among others. The usage data may be received from vehicle 220, repair facilities 230, and/or mobile valuation device 212. Also, as discussed above, various vehicle sensors may provide information for determining the usage data. For example, sensors including an accelerometer, gyroscope, a microphone, a vibration detector, an odometer, the driving analysis system 224, or a navigation system may inform the usage data.

At step 520, a value of the vehicle may be determined, based on the usage data and the group of sensor data matching the pre-determined group. For example, the usage data and the pre-determined grouping of sensor data may indicate the catalytic converter or the muffler in the vehicle 220 is not operating properly. This may be based the usage data indicating that the vehicle 220 is aged and the sensor data may indicate that abnormal O₂ values, high backpressure in the exhaust system, and lowered fuel efficiency. For example, historical data may indicate this usage data and sensor data as an indication of a failing catalytic converter. Accordingly, the vehicle valuation system 202 may determine the cost of the catalytic converter and the cost of the labor involved in replacing the catalytic converter and may reduce the value of the vehicle 220 by a similar amount.

In some embodiments, the usage data may indicate mileage added to vehicle 220 since the sensor data was generated. Similar to the above, the vehicle valuation system 202 may further reduce the vehicle value if it is determined that the vehicle has continued in operation after the sensor data was generated, as this may be an indicator that more extensive damage may have occurred to the vehicle 220.

In some embodiments, the vehicle valuation system 202 may determine that a same grouping of sensor data had been previously generated by the vehicle 220. Such a determination may be an indication that the vehicle 220 had a chronic condition, or that previous repairs had not lasted or been successful, or that the vehicle owner had cleared the sensor data and continued using the vehicle 220, without making repairs. The vehicle valuation system 202 may reduce the vehicle value based on these indications.

In some embodiments, the vehicle valuation system 202 may determine that a same grouping of sensor data had been previously generated by the vehicle 220 by communicating with repair facilities 230.

Aspects of the invention have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the figures may be performed in other than the recited order, and that one or more steps illustrated may be optional in accordance with aspects of the invention.

What is claimed is:

1. A method for determining a value of a vehicle, comprising:
receiving, by a computing device, fault codes generated by the vehicle;
analyzing the fault codes using an algorithm;
determining, based on the analyzed fault codes, that the fault codes comprise a group of fault codes matching a pre-determined grouping;
receiving usage data associated with the vehicle; and
based on the usage data and the determination that the fault codes comprise the group of fault codes matching the pre-determined grouping, determining the value of the vehicle.

2. The method of claim 1, wherein the fault codes comprise On Board Diagnostics (OBD) codes.

3. The method of claim 1, further comprising:
determining a repair corresponding to the pre-determined grouping, wherein the determining the value is based on a cost of the repair.

4. The method of claim 1, wherein the usage data indicates mileage added since the fault codes were generated.

5. The method of claim 1, further comprising:
determining that a same group of fault codes matching the pre-determined grouping has been previously generated by the vehicle; and
reducing the value of the vehicle.

6. The method of claim 1, further comprising:
receiving a repair history of the vehicle from a repair shop, a manufacturer of the vehicle, or a roadside assistance service; and
determining that a repair associated with the pre-determined grouping has been previously performed on the vehicle; and
reducing the value of the vehicle.

7. The method of claim 1, further comprising:
determining that prior fault codes matching the pre-determined grouping been previously generated by the vehicle;
receiving a repair history of the vehicle from a repair shop, a manufacturer of the vehicle, or a roadside assistance service; and
based on the repair history, determining that the prior fault codes were cleared without a corresponding repair being performed on the vehicle; and
reducing the value of the vehicle.

8. A method for determining a value of a vehicle, comprising:
receiving, by a computing device, fault codes generated by the vehicle;
receiving sensor data generated by the vehicle;
analyzing the fault codes and the sensor data using an algorithm;
determining, based on the analyzed fault codes and sensor data, that the fault codes and the sensor data comprise a pre-determined grouping;
receiving usage data associated with the vehicle; and
based on the usage data and the determination that the fault codes and the sensor data comprise the pre-determined grouping, determining the value of the vehicle.

9. The method of claim 8, wherein the fault codes comprise On Board Diagnostics (OBD) codes.

10. The method of claim 8, further comprising:
determining a repair corresponding to the pre-determined grouping, wherein the determining the value is based on a cost of the repair.

11. The method of claim 8, wherein the usage data indicates mileage added since the fault codes and the sensor data were generated.

12. The method of claim 8, further comprising:
determining that prior fault codes and prior sensor data matching the pre-determined grouping has been previously generated by the vehicle; and
reducing the value of the vehicle.

13. The method of claim 8, further comprising:
receiving a repair history of the vehicle from a repair shop, a manufacturer of the vehicle, or a roadside assistance service; and
determining that a repair associated with the pre-determined grouping has been previously performed on the vehicle; and
reducing the value of the vehicle.

14. The method of claim 8, further comprising:
determining that prior fault codes and prior sensor data matching the pre-determined grouping has been previously generated by the vehicle;
receiving a repair history of the vehicle from a repair shop, a manufacturer of the vehicle, or a roadside assistance service; and
based on the repair history, determining that the prior fault codes were cleared without a corresponding repair being performed on the vehicle; and
reducing the value of the vehicle.

15. The method of claim 8, wherein the usage data is based on information received from an accelerometer, a gyroscope, a microphone, a vibration detector, an odometer, a driving analysis system, or a navigation system.

16. One or more non-transitory computer-readable media storing further instructions that, when executed by a computing device, cause the computing device to:
receive sensor data generated by a vehicle;
analyze the sensor data using an algorithm;
determine, based on the analyzed sensor data, that the sensor data comprises a pre-determined grouping of sensor data;
receive usage data associated with the vehicle; and
based on the usage data and the determination that the sensor data comprises the pre-determined grouping, determine a value of the vehicle.

17. The one or more non-transitory computer-readable media of claim 16, storing further instructions that, when executed by the computing device, cause the computing device to:
determine a repair corresponding to the pre-determined grouping, wherein the determining the value of the vehicle is further based on a cost of the repair.

18. The one or more non-transitory computer-readable media of claim 16, wherein the usage data indicates mileage added since the sensor data were generated.

19. The one or more non-transitory computer-readable media of claim 16, storing further instructions that, when executed by the computing device, cause the computing device to:
determine that prior sensor data matching the pre-determined grouping has been previously generated by the vehicle; and
reduce the value of the vehicle.

20. The one or more non-transitory computer-readable media of claim 16, storing further instructions that, when executed by the computing device, cause the computing device to:
receive a repair history of the vehicle from a repair shop, a manufacturer of the vehicle, or a roadside assistance service; and
determine that a repair associated with the pre-determined grouping has been previously performed on the vehicle; and
reduce the value of the vehicle.
